(19) United States
(12) Patent Application Publication
(10) Pub. No.: US 2013/0284210 A1
(43) Pub. Date: Oct. 31, 2013

(54) SOLID FORMULATIONS, THEIR PREPARATION AND USE

(71) Applicant: BASF SE, Ludwigshafen (DE)

(72) Inventors: Stephan HUEFFER, Ludwigshafen (DE); Alejandra GARCIA MARCOS, Ludwigshafen (DE); Markus HARTMANN, Neustadt (DE)

(73) Assignee: BASF SE, Ludwigshafen (DE)

(21) Appl. No.: 13/866,350

(22) Filed: Apr. 19, 2013

Related U.S. Application Data
(60) Provisional application No. 61/637,891, filed on Apr. 25, 2012.

(30) Foreign Application Priority Data
May 15, 2012 (EP) 12168044.1

(51) Int. Cl. C11D 7/32

(52) U.S. Cl. CPC C11D 7/3245
USPC 134/25.2; 510/218; 510/219; 264/5

(57) ABSTRACT

Use of solid formulations with a residual moisture content in the range from 0.1 to 15% by weight, comprising
(A) at least one compound selected from aminocarboxylates and polyaminocarboxylates, and
(B) at least one cationic (co)polymer with a cationic charge density of at least 5 milliequivalents/g,
(C) at least one silicate selected from sodium silicates, potassium silicates and alumosilicates,
(D) optionally at least one compound selected from alkali metal percarbonate, alkali metal perborate and alkali metal persulfate, and
(E) optionally, polyvinyl alcohol
   as or for producing formulations for washing dishes and kitchen utensils.

The present invention relates to the use of solid formulations with a residual moisture content in the range from 0.1 to 15% by weight, comprising
(A) at least one compound selected from aminocarboxylates and polyaminocarboxylates, and
(B) at least one cationic (co)polymer with a cationic charge density of at least 5 milliequivalents/g,
(C) at least one silicate selected from sodium silicates, potassium silicates and alumosilicates,
(D) optionally at least one compound selected from alkali metal percarbonate, alkali metal perborate and alkali metal persulfate, and
(E) optionally, polyvinyl alcohol,
   as or for producing formulations for washing dishes and kitchen utensils.

Furthermore, the present invention relates to solid formulations and to a process for producing solid formulations according to the invention.

Modern dishwashing detergents have to meet many requirements. For example, they have to clean the dishes thoroughly, they should leave behind no harmful or potentially harmful substances in the wastewater, they should permit the run-off and drying of the water from the dishes, and they should not lead to problems during the operation of the dishwasher. Finally, they should not lead to esthetically undesirable results on the item to be cleaned. In this connection, glass corrosion is to be mentioned in particular.

Glass corrosion arises not only as a result of mechanical effects, for example as a result of glasses rubbing together or mechanical contact between the glasses and parts of the dishwasher, but is primarily promoted by chemical influences. For example, certain ions can be dissolved out of the glass as a result of repeated machine cleaning, which adversely alters the optical and thus esthetic properties.

Several effects are observed with glass corrosion. Firstly, the formation of microscopically fine cracks can be observed which become noticeable in the form of lines. Secondly, in many cases, general hazing can be observed, for example a roughening which makes the glass in question appear unattractive. Effects of this type are overall also subdivided into iridescent discoloration, scoring, as well as patchy and circular clouding.

It is known from WO 2002/64719 that certain copolymers of ethylenically unsaturated carboxylic acids with, for example, esters of ethylenically unsaturated carboxylic acids can be used in dishwashing detergents.

WO 2010/020765 discloses dishwashing detergents which comprise polyethyleneimine. Dishwashing detergents of this type can comprise phosphate or be phosphate-free. They are attributed good inhibition of glass corrosion. Zinc-containing and bismuth-containing dishwashing detergents are discouraged. Glass corrosion, in particular line corrosion and clouding, however, is in many cases still not adequately delayed or prevented.

EP 2 392 638 discloses how aminocarboxylates can be used in a mixture with silicates or with a second aminocarboxylate in order to produce the less hygroscopic formulations for automatic dishwashing. However, glass corrosion cannot be adequately controlled efficiently in many cases.

It was therefore the object to provide formulations which are suitable for use as or for producing dishwashing detergents and which avoid the disadvantages known from the prior art and which inhibit glass corrosion or at least reduce it particularly well. It was also the object to provide a process for producing formulations which are suitable as or for producing dishwashing detergents and which avoid the disadvantages known from the prior art. It was also the object to provide uses of formulations.

Accordingly, the formulations defined at the outset have been found, also called for short formulations according to the invention, and the corresponding use as or for producing formulations for the automatic washing of dishes and kitchen utensils.

Formulations used according to the invention have a residual moisture in the range from 0.1 to 15% by weight, preferably at least 2 to 10% by weight, particularly preferably 4 to 7% by weight. In this connection, the residual moisture is based on total formulation used according to the invention. The residual moisture can preferably be determined gravimetrically, for example by drying formulation according to the invention at 120° C. to a constant weight.

Formulations used according to the invention comprise

(A) at least one compound selected from aminocarboxylates and polyaminocarboxylates, in the scope of the present invention also called for short aminocarboxylate (A) or polyaminocarboxylate (A) or else compound (A), and also preferably salts thereof.

Compound (A) can be present as a free acid or preferably in partially or completely neutralized form, i.e. as a salt. Suitable counterions are, for example, inorganic cations, for example ammonium, alkali metal or alkaline earth metal, preferably Mg²⁺, Ca²⁺, Na⁺, K⁺, or organic cations, preferably ammonium substituted with one or more organic radicals, in particular triethanolammonium, N,N-diethanolammonium, N-mono-C₁-C₄-alkyldiethanolammonium, for example N-methyldiethanolammonium or N-n-butyldiethanolammonium, and N,N-di-C₁-C₄-alkylethanolammonium.

Within the context of the present invention, aminocarboxylates (A) are understood as meaning nitrilotriacetic acid and those organic compounds which have a tertiary amino group which has one or two CH₂—COOH groups which—as mentioned above—can be partially or completely neutralized. Within the context of the present invention, polyaminocarboxylates (A) are understood as meaning those organic compounds which have at least two tertiary amino groups, each of which, independently of the other, has one or two CH₂—COOH groups which—as mentioned above—can be partially or completely neutralized.

In another embodiment of the present invention, aminocarboxylates (A) are selected from those organic compounds which have a secondary amino group which has one or two CH(COOH)CH₂—COOH group(s) which—as mentioned above—can be partially or completely neutralized. In another embodiment of the present invention, polyaminocarboxylates (A) are selected from those organic compounds which have at least two secondary amino groups each of which has one CH(COOH)CH₂—COOH group which—as mentioned above—can be partially or completely neutralized.

Preferred polyaminocarboxylates (A) are selected from 1,2-diaminoethanetetraacetic acid (EDTA), diethylenetriamine pentaacetate (DTPA), hydroxyethylenediamine triacetate (HEDTA), and their respective salts, particularly preferably alkali metal salts, in particular the sodium salts.

Preferred amino carboxylates (A) and polyaminocarboxylates (A) are nitrilotriacetic acid and those organic compounds which have a structure based on an amino acid, the amino group(s) of which has or have one or two CH₂—COOH groups and are tertiary amino groups. In this connection, amino acids can be selected from L-amino acids, R-amino acids and enantiomer mixtures of amino acids, for example the racemates.

In one embodiment of the present invention, compound (A) is selected from methylglycine diacetate (MGDA), iminodisuccinic acid (IDA) and glutamic acid diacetate (GLDA) and also preferably from salts thereof, in particular the sodium salts of MGDA, IDA and GLDA. Very particular preference is given to methylglycine diacetate and also the trisodium salt of MGDA.

Formulation used according to the invention further comprises

(B) at least one cationic (co)polymer with a cationic charge density of at least 5 milliequivalents/g, for short also called cationic (co)polymer (B). Preferred (co)polymers (B) are selected from polyvinylamine and linear and branched homopolymers of alkyleneimine. Particularly preferred (co)polymers (B) are selected from homopolymers and copolymers of ethyleneimine, for short also called polyethyleneimine (B), and homopolymers and copolymers of propyleneimine, for short also called polypropyleneimine (B).

Within the context of the present invention, cationic (co)polymers (B) are understood as meaning those (co)polymers which have at least one of the following structural features:
(i) permanent cationic charges, for example quaternary nitrogen atoms, for example in the form of trialkylammonium groups, 3-alkylimidazolium groups, 3-arylimidazolium groups, tetra(2-aminoethyl) groups, tetra(2-iminoethyl) groups, N-pyridinium groups, or N,N-dialkylimino groups, preferably tri-C₁-C₄-n-alkylammonium groups, 3-methylimidazolium groups, 3-phenylimidazolium groups and tetra(2-aminoethyl) groups, or
(ii) basic nitrogen atoms which are protonated at a pH of for example 5 or less, preferably 1 to 3, in aqueous medium. Examples are —NH₂ groups, —NH(C₁-C₁₀-alkyl) groups, —N(C₁-C₁₀-alkyl)₂ groups, —NH(C₂-C₁₀-alkylene) groups, —(CH₂)₂—N(CH₃)₂ groups, NH—CH₂CH(C₁-C₁₀-alkyl) groups and —(C₂-C₁₀-alkylene)N(C₂-C₁₀-alkylene) groups, in particular CH₂—CH₂—NH—CH₂—CH₂—NH groups and CH₂—CH₂—NH—(CH₂)₃—NH groups.

Cationic (co)polymer (B) can have, per molecule, at least two structural features (i) which may be identical or different, or at least two structural features (ii), which may be identical or different, or at least one structural feature (i) and at least one structural feature (ii). Preferably, cationic (co)polymer has, per molecule of (B), at least five structural features (i), which may be identical or different, or at least five structural features (ii), which may be identical or different.

Cationic (co)polymer (B) can have, as counterions, high molecular weight or low molecular weight anions, organic or preferably inorganic. Within the context of the present invention, high molecular weight anions have an average molecular weight of 200 g/mol or more, for example up to 2500 g/mol, low molecular weight anions have a molecular weight of less than 200 g/mol, for example from 17 to 150 g/mol. Examples of low molecular weight organic counterions are acetate, propionate and benzoate. Examples of low molecular weight inorganic counterions are sulfate, chloride, bromide, hydroxide, carbonate, methanesulfonate and hydrogencarbonate.

Cationic (co)polymers (B) have a cationic charge density of at least 5 milliequivalents/g, the data in g referring to cationic (co)polymer (B) without taking into consideration the counterions. Preferably, a charge density is in the range from 5 to 22 milliequivalents/g. The cationic charge density can be ascertained, for example, by titration.

Cationic (co)polymers (B) can also comprise one or more anionic comonomers in polymerized-in form, for example (meth)acrylic acid. Cationic copolymers (B), which also comprise one or more anionic comonomers in polymerized-in form, however, have more cationic than anionic charges per molecule.

In another embodiment of the present invention, cationic (co)polymer (B) comprises no anionic comonomers in polymerized-in form.

Examples of cationic (co)polymers (B) are polyvinylamine-co-vinylformamide, preparable for example by partial hydrolysis of polyvinylformamide, also polyvinylpyrrolidone, polyDADMAC (DADMAC: diallyldimethylammonium chloride), polyvinylpyrrolidone-co-vinyl-3-methylimidazolium, graft copolymers of 3-methyl-N-vinylimidazolium on polyethers such as, for example, polyethylene glycol or polypropylene glycol, graft copolymers of 3-methyl-N-vinylimidazolium and N-vinylpyrrolidone on polyethers such as, for example, polyethylene glycol or polypropylene glycol.

Further examples of cationic (co)polymers (B) are copolymers of (meth)acrylates with N,N-dimethylaminoethyl (meth)acrylate and copolymers of (meth)acrylates with N,N,N-trimethylammonium ethyl (meth)acrylate. A further example is cationically modified starch.

According to one particular embodiment of the invention, cationic (co)polymer (B) has an average molecular weight Mₙ of from 500 g/mol to 125 000 g/mol, preferably from 750 g/mol to 100 000 g/mol.

In one embodiment of the present invention, cationic (co)polymer (B) has an average molecular weight M_{w} in the range from 500 to 1 000 000 g/mol, preferably in the range from 600 to 75 000 g/mol, particularly preferably in the range from 800 to 25 000 g/mol, determinable for example by gel permeation chromatography (GPC).

Preferred (co)polymers (B) are selected from polyvinylamines, for short also called polyvinylamines (B), and from linear and branched homopolymers of alkyleneimines, for short called polyalkyleneimine (B), and in particular from linear and branched homopolymers of ethyleneimine and/or propyleneimine, for short called polyethyleneimine (B) or polypropyleneimine (B).

Examples of polyvinylamines (B) are not only completely saponified polyvinylamides, for example completely saponified poly-N-vinylformamide, but also so-called hydrophobically modified polyvinylamines, for example by reaction with
one or more linear carboxylic acid(s) having 10 to 22 carbon atoms/molecule, preferably having 14 to 18 carbon atoms/molecule, for example capric acid, undecanoic acid, lauric acid, tridecanoic acid, myristic acid, pentadecanoic acid, palmitic acid, margaric acid, stearic acid, arachic acid, nonadecanoic acid, linoleic acid, oleic acid, palmitoleic acid, arachidonic acid, behenic acid, preference being given to stearic acid, oleic acid and palmitic acid, and esters thereof, in particular ethyl or methyl esters, the acid chlorides thereof or anhydrides thereof,
one or more linear or branched alkyl halide(s) having 10 to 22 carbon atoms/molecule, preferably having 14 to 18 carbon atoms/molecule, for example n-tetradecyl chloride, n-hexadecyl chloride, n-octadecyl chloride,
one or more alkyl epoxides having 10 to 22 carbon atoms/molecule, for example 1,2-hexadecenyl oxide and 1,2-octadecenyl oxide,
alkyl ketene dimers having 9 to 21 carbon atoms in the respective alkyl radical, preferably up to 18 carbon atoms, for example dimeric lauryl ketene, dimeric palmityl ketene, dimeric stearyl ketene and dimeric oleyl ketene, or mixtures thereof,
cyclic dicarboxylic anhydrides, in particular alkyl-substituted succinic anhydrides having 10 to 22 carbon atoms in the alkyl radical, preferably having 14 to 18 carbon atoms in the alkyl radical, for example dodecenylsuccinic anhydride, tetradecylsuccinic anhydride, hexadecenylsuccinic anhydride, and with mixtures thereof,
chloroformic acid esters of fatty alcohols having 10 to 22 carbon atoms in the alkyl radical, preferably having 14 to 18 carbon atoms in the alkyl radical,
alkylene diisocyanates having 10 to 22 carbon atoms in the alkylene radical, preferably having 14 to 18 carbon atoms in the alkyl radical, for example OCN—(CH₂)₁₄—NCO, OCN—(CH₂)₁₆—NCO or OCN—(CH₂)₁₈—NCO or mixtures of at least two of the aforementioned compounds.

Within the context of the present invention, polyalkyleneimine (B) can be prepared not only by polymerization of alkyleneimine, but for example also by polycondensation of α,ω-hydroxy-C₂-C₁₀-alkyleneamines, by polycondensation of α,ω-C₂-C₁₀-alkylenediamines with α,ω-hydroxy-C₂-C₁₀-alkylenediols or by polycondensation of α,ω-C₂-C₁₀-alkylenediamines. One example of the polycondensation of α,ω-hydroxy-C₂-C₁₀-alkyleneamines is the polycondensation of triethanolamine.

In one embodiment of the present invention polyethyleneimine (B) has an average molecular weight M_{w} in the range from 600 to 75 000 g/mol, preferably in the range from 800 to 25 000 g/mol.

In one embodiment of the present invention, polyethyleneimines (B) are selected from highly branched polyethyleneimines (B). Highly branched polyethyleneimines (B) are characterized by their high degree of branching (DB). The degree of branching can be determined for example by ¹³C-NMR spectroscopy, preferably in D₂O, and is defined as follows:

DB=D+T/D+T+L

with D (dendritic) corresponding to the fraction of tertiary amino groups, L (linear) corresponding to the fraction of secondary amino groups and T (terminal) corresponding to the fraction of primary amino groups.

Within the context of the present invention, highly branched polyethyleneimines (B) are polyethyleneimines (B) with DB in the range from 0.1 to 0.95, preferably 0.25 to 0.90, particularly preferably in the range from 0.30 to 0.80 and very particularly preferably at least 0.5.

Within the context of the present invention, dendrimeric polyethyleneimines (B) are polyethyleneimines (B) with a structurally and molecularly uniform constitution.

In one embodiment of the present invention, polyethyleneimine (B) is highly branched polyethyleneimines (homopolymers) with an average molecular weight M_{w} in the range from 600 to 75 000 g/mol, preferably in the range from 800 to 25 000 g/mol.

According to a particular embodiment of the invention, polyethyleneimine (B) is highly branched polyethyleneimines (homopolymers) with an average molecular weight Mₙ of from 500 g/mol to 125 000 g/mol, preferably from 750 g/mol to 100 000 g/mol, which are selected from dendrimers.

In one embodiment of the present invention, polyethyleneimine (B) is a polyethylineimine modified with carboxylate groups or alkoxylate groups in particular a polyethyleneimine modified with ethoxylate, propoxylate or acetate—by Michael addition of acrylic acid.

Formulations used according to the invention comprise at least one silicate, also called silicate (C) for short, selected from sodium silicates, potassium silicates and alumosilicates. Examples are, in particular sodium disilicate and sodium metasilicate, alumosilicates (zeolites) and sheet silicates.

In one embodiment of the present invention, silicate (C) is selected from those of the formal composition

M₂O.xSiO₂

where M is selected from potassium, mixtures of potassium and sodium or preferably sodium and x is in the range from 1 to 3.5, preferably in the range from 1.6 to 2.6 and particularly preferably in the range from 1.8 to 2.2. Particular preference is given to silicates of the formula α-Na₂Si₂O₅, β-Na₂Si₂O₅, and δ-Na₂Si₂O₅.

In one embodiment of the present invention silicate (C) is selected from hydrous silicates, where water can be physisorbed or chemically bonded.

In one embodiment of the present invention, silicate (C) has a zeta potential zero. In one embodiment of the present invention, silicate (C) in combination with cationic (co)polymer (B) has a zeta potential ≦zero.

In one embodiment of the present invention, silicate (C) has an average primary particle diameter (number-average) in the range from 10 to 1000 nm, preferably 50 to 500 nm, determinable for example by image analysis with the help of electron microscopy.

In one embodiment of the present invention, silicate (C) in formulation according to the invention is composed of agglomerates of silicate primary particles. In this connection, the specified agglomerates can have an average diameter (number-average) in the range from 0.5 to 100 μm, preferably 1 to 20 μm (determinable for example by means of electron microscope or by means of Coulter counter).

Formulations used according to the invention can also comprise:
(D) at least one compound selected from alkali metal percarbonate, alkali metal perborate and alkali metal persulfate, within the context of the present invention also called “bleach (D)”.

Preferred bleaches (D) are selected from sodium perborate, anhydrous or for example, as monohydrate or as tetrahydrate or so-called dihydrate, sodium percarbonate, anhydrous or for example, as monohydrate, and sodium persulfate, the term “persulfate” in each case including the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, preference is given in each case to the dialkali metal salts.

In one embodiment of the present invention, formulation according to the invention comprises polyvinyl alcohol (E), where, within the context of the present invention, polyvinyl alcohol comprises completely or largely, for example, to at least 95 mol %, preferably to at least 96 mol %, hydrolyzed polyvinyl acetate. In one embodiment of the present invention, formulation according to the invention can comprise polyvinyl alcohol (E), for example 0.5 to 5% by weight, based on the solids content of formulation used according to the invention.

In one embodiment of the present invention, polyvinyl alcohol (E) has an average molecular weight Mₙ in the range from 22 500 to 115 000 g/mol, for example up to 40 000 g/mol. In one embodiment of the present invention, polyvinyl alcohol (E) has an average molecular weight Mw in the range from 2000 to 40 000 g/mol.

In one embodiment of the present invention, formulations used according to the invention comprise

in total in the range from 1 to 50% by weight of compound (A), preferably 10 to 25% by weight,

in total 0.001 to 2% by weight of cationic (co)polymer (B), preferably 0.02 to 0.5% by weight,

in the range from 1 to 30% by weight of silicate (C) and

in total zero to 15% by weight of bleach (D), selected from alkali metal percarbonate, alkali metal perborate and alkali metal persulfate,

in total in the range from zero to 5% by weight of polyvinyl alcohol (E),

based in each case on solids content of the formulation in question.

In one variant of the present invention, formulation according to the invention comprises compound (A) and cationic (co)polymer (B) in a weight ratio of 1000:1 to 25:1.

In one embodiment of the present invention, formulation according to the invention is solid at room temperature, for example a powder or a tablet. In another embodiment of the present invention, formulation according to the invention is liquid at room temperature. In one embodiment of the present invention, formulation according to the invention is granules, a liquid formulation or a gel.

In one embodiment of the present invention, formulation according to the invention is free from phosphates and polyphosphates, with hydrogenphosphates being subsumed, for example free from trisodium phosphate, pentasodium tripolyphosphate and hexasodium metaphosphate. In connection with phosphates and polyphosphates, “free from” should be understood within the context of the present invention as meaning that the content of phosphate and polyphosphate is in total in the range from 10 ppm to 0.2% by weight, determined by gravimetry.

In one embodiment of the present invention, formulation according to the invention is free from those heavy metal compounds which do not act as bleach catalysts, in particular from compounds of iron and of bismuth. In connection with heavy metal compounds, within the context of the present invention, “free from” should be understood as meaning that the content of heavy metal compounds which do not act as bleach catalysts is in total in the range from 0 to 100 ppm, determined in accordance with the Leach method and based on the solids content. Preferably, formulation according to the invention has a heavy metal content below 0.05 ppm.

Within the context of the present invention, “heavy metals” are all metals having a specific density of at least 6 g/cm³. In particular, heavy metals are precious metals and also zinc, bismuth, iron, copper, lead, tin, nickel, cadmium and chromium.

Preferably, formulation according to the invention comprises no measurable fractions of zinc and bismuth compounds, i.e. for example less than 1 ppm.

In one embodiment of the present invention, formulation used according to the invention can have further ingredients (F), for example one or more surfactants, one or more enzymes, one or more builders, in particular phosphorus-free builders, one or more cobuilders, sodium citrate, one or more alkali carriers, one or more bleaches, one or more bleach catalysts, one or more bleach activators, one or more bleach stabilizers, one or more antifoams, one or more corrosion inhibitors, one or more builder substances, buffers, dyes, one or more fragrances, one or more organic solvents, one or more tableting auxiliaries, one or more disintegrants, one or more thickeners, or one or more solubility promoters.

Examples of surfactants are in particular nonionic surfactants and also mixtures of anionic or zwitterionic surfactants with nonionic surfactants. Preferred nonionic surfactants are alkoxylated alcohols and alkoxylated fatty alcohols, di- and multiblock copolymers of ethylene oxide and propylene oxide and reaction products of sorbitan with ethylene oxide or propylene oxide, alkyl glycosides and so-called amine oxides.

Preferred examples of alkoxylated alcohols and alkoxylated fatty alcohols are, for example, compounds of the general formula (I)

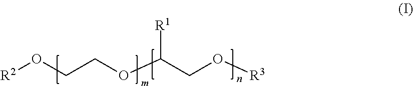

in which the variables are defined as follows:
R¹ is identical or different and selected from linear C₁-C₁₀-alkyl, preferably in each case identical and ethyl and particularly preferably methyl,
R² is selected from C₈-C₂₂-alkyl, for example n-C₈H₁₇, n-C₁₀H₂₁, n-C₁₂H₂₅, n-C₁₄H₂₉, n-C₁₈H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

m and n are in the range from zero to 300, where the sum of n and m is at least one. Preferably, m is in the range from 1 to 100 and n is in the range from 0 to 30.

Here, compounds of the general formula (I) may be block copolymers or random copolymers, preference being given to block copolymers.

Other preferred examples of alkoxylated alcohols and alkoxylated fatty alcohols are, for example, compounds of the general formula (II)

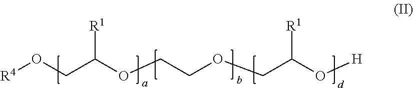

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from 1 to 6,
b is a number in the range from 4 to 20,
d is a number in the range from 4 to 25.

Here, compounds of the general formula (II) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl glycosides are likewise suitable. An overview of suitable further nonionic surfactants can be found in EP-A 0 851 023 and in DE-A 198 19 187.

Mixtures of two or more different nonionic surfactants may also be present. Examples of anionic surfactants are C₈-C₂₀-alkyl sulfates, C₈-C₂₀-alkylsulfonates and C₈-C₂₀-alkyl ether sulfates with one to 6 ethylene oxide units per molecule.

In one embodiment of the present invention, formulations used according to the invention can comprise in the range from 3 to 20% by weight of surfactant.

Formulations used according to the invention can comprise one or more enzymes. Examples of enzymes are lipases, hydrolases, amylases, proteases, cellulases, esterases, pectinases, lactases and peroxidases.

Formulations used according to the invention can comprise, for example, up to 5% by weight of enzyme, preference being given to 0.1 to 3% by weight, in each case based on the total solids content of the formulation according to the invention.

Over and above sodium citrate, formulations used according to the invention can comprise one or more builders, in particular phosphate-free builders. Examples of suitable builders are citric acid and its alkali metal salts, in particular sodium citrate, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid. Particular preference is given to sodium citrate.

In one embodiment of the present invention, builders are selected from polycarboxylates, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Formulations used according to the invention can comprise, for example, in the range from in total 10 to 50% by weight, preferably up to 20% by weight, of builders.

In one embodiment of the present invention, formulations used according to the invention can comprise one or more cobuilders.

Examples of cobuilders are phosphonates, for example hydroxyalkanephosphonates and aminoalkanephosphonates. Among the hydroxyalkanephosphonates, 1-hydroxyethane-1,1-diphosphonate (HEDP) is of particular importance as a cobuilder. It is preferably used as the sodium salt, the disodium salt giving a neutral reaction and the tetrasodium salt an alkaline reaction (pH 9). Suitable aminoalkanephosphonates are preferably ethylenediaminetetra-methylenephosphonate (EDTMP), diethylenetriaminepentamethylenephosphonate (DTPMP) and higher homologs thereof. They are preferably used in the form of the neutrally reacting sodium salts, e.g. as hexasodium salt of EDTMP or as hepta- and octasodium salt of DTPMP. Formulations according to the invention can comprise sodium citrate. In this connection, the term sodium citrate comprises the mono-, the disodium salt, but particularly preferably denotes the trisodium salt. Sodium citrate can be used as anhydrous salt or as hydrate, for example, as dihydrate.

Formulations used according to the invention can comprise one or more alkali carriers. Alkali carriers ensure, for example, a pH of at least 9 if an alkaline pH is desired. Of suitability are, for example, alkali metal carbonates, alkali metal hydrogen carbonates, alkali metal hydroxides and alkali metal metasilicates. A preferred alkali metal is in each case potassium, particular preference being given to sodium.

Besides bleach (D), formulations used according to the invention can comprise one or more chlorine-containing bleaches.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Formulations used according to the invention can comprise, for example, in the range from 3 to 10% by weight of chlorine-containing bleach.

Formulations used according to the invention can comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations used according to the invention can comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Other examples of suitable bleach activators are tetraacetylethylenediamine (TAED) and tetraacetylhexylenediamine.

Formulations used according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations used according to the invention comprise in total in the range from 0.1 to 1.5% by weight of corrosion inhibitor.

Formulations used according to the invention can comprise one or more builder substances, for example sodium sulfate.

Formulations used according to the invention can comprise one or more antifoams, selected for example from silicone oils and paraffin oils.

In one embodiment of the present invention, formulations used according to the invention comprise in total in the range from 0.05 to 0.5% by weight of antifoam.

Formulations used according to the invention can comprise phosphonic acid or one or more phosphonic acid derivatives, for example hydroxyethane-1,1-diphosphonic acid.

According to the invention, formulations described above are used for the machine cleaning of dishes and kitchen utensils. Within the scope of the present invention, kitchen utensils which may be mentioned are, for example, pots, pans, casseroles, also objects made of metal such as, for example, slotted spoons, fish slices and garlic presses.

Preference is given to the use of formulations according to the invention for the machine cleaning of objects which have at least one surface made of ceramic or preferably glass, which may be decorated or undecorated. In this connection, within the context of the present invention, a surface made of glass is to be understood as meaning that the object in question has at least one section made of glass which comes into contact with the ambient air and can become soiled upon use of the object. Thus, the objects in question may be those which, like drinking glasses or glass bowls, are essentially made of glass. However, they may, for example, also be lids which have individual components made of a different material, for example pot lids with rim and handle made of metal or ceramic.

Surfaces made of ceramic or preferably glass can be decorated, for example colored or imprinted, or be undecorated.

The term “glass” includes any desired types of glass, for example lead glass and in particular soda-lime glass, crystal glass and borosilicate glasses.

Preferably, machine cleaning is washing with a dishwasher (automatic dishwashing).

In one embodiment of the present invention, at least one formulation according to the invention is used for the machine cleaning of drinking glasses, glass vases and glass vessels for cooking.

In one embodiment of the present invention, for the cleaning, water with a hardness in the range from 1 to 30° German hardness, preferably 2 to 25° German hardness is used, with German hardness being understood in particular as meaning the calcium hardness.

If, according to the invention, formulations are used for machine cleaning, then even in the case of repeated machine cleaning of objects which have at least one surface made of glass, only a very slight tendency towards glass corrosion is observed, and only then if objects which have at least one surface made of glass are cleaned together with heavily soiled cutlery or dishes. Furthermore, it is significantly less harmful to use the formulation according to the invention to clean glass together with objects made of metal, for example together with pots, pans or garlic presses.

The present invention further provides formulations with a residual moisture content of from 0.1 to 15% by weight, preferably up to 10% by weight, comprising
(A) at least one compound selected from aminocarboxylates and polyaminocarboxylates, and
(B) at least one cationic (co)polymer with a cationic charge density of at least 5 milliequivalents/g,
(C) at least one silicate selected from sodium silicates, potassium silicates and alumosilicates,
(D) optionally at least one compound selected from alkali metal percarbonate, alkali metal perborate and alkali metal persulfate, and
(E) optionally, polyvinyl alcohol.

Compound (A), cationic (co)polymer (B), silicate (C) and bleach (D) and also polyvinyl alcohol (E) are described above.

In one embodiment of the present invention, formulation according to the invention is free from phosphates and polyphosphates. The expression “free from” in connection with phosphates and polyphosphates is defined above.

In one embodiment of the present invention, cationic (co)polymer (B) is selected from polyvinylamine and linear and branched homopolymers of alkyleneimine, in particular from linear and branched homopolymers of ethyleneimine and/or propyleneimine.

In one embodiment of the present invention, formulation according to the invention has a heavy metal content in the range from 0 to 100 ppm, preferably below 0.05 ppm, based on the solids content of the formulation in question.

In one embodiment of the present invention formulation according to the invention can comprise polyvinyl alcohol, for example 0.5 to 5% by weight, based in each case on the solids content of the formulation according to the invention in question.

In one embodiment of the present invention, compound (A) is selected from methylglycine diacetate (MGDA), iminodisuccinic acid (IDS) and glutamic acid diacetate (GLDA) and also salts thereof, in particular the sodium salts.

In one embodiment of the present invention, formulation according to the invention comprises:

in total in the range from 1 to 50% by weight of compound (A),

in total in the range from 0.001 to 2% by weight of cationic (co)polymer (B),

in the range from 1 to 30% by weight of silicate (C) and

in total in the range from zero to 15% by weight of bleach (D)

in total in the range from zero to 5% by weight of polyvinyl alcohol (E),

based in each case on the solids content of the formulation in question.

In one embodiment of the present invention, silicate (C) in formulation according to the invention has an average primary particle diameter (number-average) in the range from 10 to 1000 nm, preferably 50 to 500 nm, determinable for example, by image analysis with the help of electron microscopy.

In one embodiment of the present invention, silicate (C) in formulation according to the invention is composed of agglomerates of silicate primary particles. In this connection, the specified agglomerates can have an average diameter in the range from 0.5 to 100 μm, preferably 1 to 20 μm (number-average, image analysis with the help of electron microscopy).

The present invention further provides a process for producing formulations according to the invention. To produce formulations according to the invention, the procedure may be such that
(A) at least one compound selected from aminocarboxylates and polyaminocarboxylates, and,
(B) at least one cationic (co)polymer with a cationic charge density of at least 5 milliequivalents/g,
(C) at least one silicate or watergiass,
(D) optionally at least one compound selected from alkali metal percarbonate, alkali metal perborate and alkali metal persulfate, and
(E) optionally, polyvinyl alcohol (E)
   are mixed together in one or more steps in the presence of water and then the water is partially removed.

Preferably, the procedure is such that water is removed by compaction or preferably by spray-drying or spray-granulation.

If it is desired to produce formulations which comprise bleach (D) and/or polyvinyl alcohol (E) and/or at least one additional component (F) (ingredient (F)), then firstly a formulation according to the invention can be prepared which comprises compound (A), cationic (co)polymer (B), silicate (C) and optionally polyvinyl alcohol (E), and this formulation can then be mixed with bleach (D) and/or one or more additional components (F), dry or in the presence of water.

In another variant, the procedure can be such that an aqueous formulation is prepared which comprises more than 15% by weight of water, based on the sum of all solids in the formulation in question, and which comprises compound (A), cationic (co)polymer (B), silicate (C), optionally polyvinyl alcohol (E) and at least one further component selected from bleach (D) and at least one additional component (F). The water is then partially removed, giving a formulation according to the invention with a residual moisture of 0.1 to 15% by weight.

In another variant, the procedure can be such that firstly a silicate (C) is treated with at least one cationic (co)polymer (B) and then—preferably in the presence of water—mixed with compound (A) and polyvinyl alcohol (E). Afterwards, the water can be partially removed. The mixture can then be mixed with bleach (D) and/or one or more additional components (F), preferably in the presence of water, and the water can then be at least partially removed.

In another variant, the procedure can be such that an aqueous formulation is prepared which comprises more than 15% by weight of water, based on the sum of all solids in the formulation in question, and which comprises compound (A), cationic (co)polymer (B), waterglass, optionally polyvinyl alcohol (E) and at least one further component, selected from bleach (D) and at least one additional component (F). The water is then partially removed, giving a formulation according to the invention with a residual moisture of from 0.1 to 15% by weight. Here, silicate (C) is formed in situ.

In a preferred embodiment of the present invention, the water is removed partially, i.e. to a residual moisture content of the formulation according to the invention in question in the range from 0.1 to 15% by weight, preferably 2 to 10% by weight, particularly preferably 4 to 7% by weight, by spray-drying or spray-granulation, using one or more spray towers and operating with a gas inlet temperature in the range from 120 to 220° C.

If it is desired to remove water by spray-drying, preferably polyvinyl alcohol (E) is added, for example, 0.5 to 5% by weight, based on the solids content of the formulation in question.

In one embodiment of the present invention the water is removed by freeze-drying.

The invention is illustrated by working examples.

General Remarks:

The charge density of cationic (co)polymers (B) was always determined as follows (see also: Horn, Prog. Colloid & Polym. Sci. 1978, 65, 251):

1 g of the (co)polymer in question was dissolved in 100 ml of demineralized water. A buffer solution and aqueous HCl were used to establish a pH of 4.0, determined potentiometrically. Three ml of an aqueous solution of toluidine blue (50 mg/l of water) were added and N/400-KPVS (potassium polyvinyl sulfate) solution (Wako) with a concentration of 0.0004 meq/ml was titrated until the color changed from blue to pink. The charge density was calculated as follows:

LA=0.4·KV

where
LA: charge density of the (co)polymer (B) in question, meq/g (milliequivalent/g)
KV: consumption of the N/400-KPVS solution [ml]

I. Preparation of Formulations According to the Invention

I.1 Preparation of Base Mixtures

Firstly, base mixtures were prepared from the feed materials according to table 1. The feed materials were mixed dry apart from the sodium silicate, which was metered in separately in the form of a 30% by weight solution.

TABLE 1
Base mixtures for experiments with formulations according
to the invention and comparison formulations

| | Base-1 | Base-2 |
|---|---|---|
| Protease | 2.5 | 2.5 |
| Amylase | 1 | 1 |
| n-C₁₈H₃₇(OCH₂CH₂)₉OH | 5 | 5 |
| Polyacrylic acid M_{w} 4000 g/mol, as sodium | 10 | 10 |
| salt, completely neutralized | | |
| Sodium percarbonate (D.1) | 10.5 | 10.5 |
| TAED | 4 | 4 |
| Na₂CO₃ | 19.5 | 19.5 |
| Sodium citrate dihydrate | 15 | 10 |
| HEDP | 0.5 | 0.5 |

All data in g.

Abbreviations:

MGDA: Methyl glycine diacetic acid as trisodium salt

TAED: N,N,N′,N′-tetraacetylethylenediamine

HEDP: Disodium salt of hydroxyethane(1,1-diphosphonic acid)

I.2 Preparation of Formulations According to the Invention I.2.1 Preparation of the Formulations According to the Invention 2 to 13 and of the Comparison Formulations C1 to C8

The following cationic (co)polymers were used:

(B.1): Polyethyleneimine homopolymer, M_{w} 800 g/mol, DB 0.63, charge density 19 meq/g

(B.2): Polyethyleneimine homopolymer, M_{w} 2000 g/mol, DB 0.64, charge density 18 meq/g

(B.3): Polyethyleneimine homopolymer, M_{w} 5000 g/mol, DB 0.67, charge density 17 meq/g

(B.4): Polyvinylamine, M_{w} 10 000 g/mol, charge density 20 meq/g

(B.5): Polyethyleneimine, ethoxylated, M_{w} 2800 g/mol, 1.0 EO/NH, charge density 8 meq/g

(B.6): Polyethyleneimine, propoxylated, M_{w} 3100 g/mol, 1.0 PO/NH, charge density 6 meq/g

(B.7): Polyethyleneimine, 20 mol % of the primary amino groups amidated with valeric acid, M_{w} 5300 g/mol, charge density 10 meq/g

(B.8): Polyethyleneimine, carboxymethylated, sodium salt, carboxymethylation 30 mol % of the primary amino groups, M_{w} 6000 g/mol, charge density 11 meq/g

(B.9): PoIyTEA (polycondensate of triethanolamine) condensate, M_{w} 3000 g/mol, charge density 5 meq/g

Procedure:

20 ml of distilled water were placed in a 100-ml beaker and cationic (co)polymer as per table 2 was added with stirring.

Stirring was carried out for 10 minutes. MGDA trisodium salt (A.1), dissolved in 30 ml of water, as per table 2 was then added. This gave a clearly transparent solution. The ca. 30% strength sodium disilicate solutions were then metered in corresponding to the amount stated in table 2 (calc. 100%). Base mixture according to table 2 was then added, the mixture was stirred again and the water evaporated.

(C.1): Na₂Si₂O₅, manufacturer PQ Corporation, 30% by weight in water

(C.2): Na₂Si₂O₅, manufacturer BASF SE, 32% by weight in water.

I.2.2: Preparation of the Formulations According to the Invention 14 to 18

Firstly, a spray solution was prepared by stirring 15 parts by weight (A.1) in 30 parts by weight of water. Cationic polymer (B) as per table 2 and then sodium disilicate solution (for amounts see table 2) were added. The spray solution obtained in this way was spray-dried (temperature of the inlet air stream: 150° C.) and then compacted. The resulting spray granules were mixed in a ratio with the base mixtures according to table 1.

This gave formulations according to the invention which were tested according to table 2.

To prepare comparison formulations the procedure was analogous but leaving cationic polymer (B) or silicate (C) out.

If, in the test, the corresponding fractions of base mixture are metered in separately from aqueous solution of (A.1), (B), (C.1) or (D.1), the same results are obtained as when the dried formulation with identical amounts of active ingredients was tested. The order of the metered addition is therefore of no consequence.

If, during the compaction, additionally 2.5% by weight of polyvinyl alcohol are used, the formulations obtained have improved powder morphology (grain size, bulk density) and a reduced water absorption in the air.

II. Use of Formulations According to the Invention and Comparison Formulations for the Machine Cleaning of Glasses

General: It was ensured that after the first cleaning of the test bodies in the domestic dishwasher until after the weighing and visual inspection of the glasses, the test bodies were handled only with clean cotton gloves so that the weight and/or the visual impression of the test bodies was not falsified.

The testing of formulations according to the invention and comparison formulations was carried out as follows.

II.1 Test Method for Dishwasher with Continuous Operation

Dishwasher: Miele G 1222 SCL

Program: 65° C. (with pre-wash)

Ware: 3 “GILDE” champagne glasses, 3 “INTERMEZZO” brandy glasses

For the cleaning, the glasses were arranged in the upper crockery basket of the dishwasher. This dishwashing detergent used was in each case 25 g of formulation according to the invention or 25 g of comparison formulation according to table 2, table 2 specifying in each case individually, the active components (A.1), base mixture, silicate (C.1 or C.2) and compound (D) or (E) and (B) of formulation according to the invention. Washing was carried out at a clear-rinse temperature of 55° C. The water hardness was in each case in the range from zero to 2° German hardness. Washing was carried out in each case for 100 wash cycles, i.e. the program was left to run 100×. The evaluation was made gravimetrically and visually after 100 wash cycles.

The weight of the glasses was determined before the start of the first wash cycle and after drying after the last wash cycle. The weight loss is the difference in the two values.

As well as the gravimetric evaluation, a visual assessment of the ware after 100 cycles in a darkened chamber with light behind a perforated plate was carried out. A grading scale from 1 (very poor) to 5 (very good) was used. In this connection, in each case grades were determined for patchy corrosion/clouding and/or line corrosion.

Experimental Procedure:

Firstly, for the purposes of pretreatment, the test bodies were washed in a domestic dishwasher (Bosch SGS5602) with 1 g of surfactant (n-C₁₈H₃₇(OCH₂CH₂)₁₀OH) and 20 g of citric acid in order to remove any soilings. The test bodies were dried, their weight was determined and they were fixed to the grid base insert.

To assess the gravimetric abrasion, the dry test bodies were weighed. Visual assessment of the test bodies was then carried out. For this, the surface of the test bodies was assessed with regard to line corrosion (score lines) and clouding corrosion (patchy clouding).

The assessments were carried out according to the following scheme.

Line Corrosion:

L5: no lines evident

L4: slight line formation in a very few areas, fine line corrosion

L3: line corrosion in some areas

L2: line corrosion in a number of areas

L1: pronounced line corrosion

Glass Clouding

L5: no clouding evident

L4: slight clouding in a very few areas

L3: clouding in some areas

L2: clouding in a number of areas

L1: pronounced clouding over virtually the entire glass surface

In the case of the inspection, interim grades (e.g. L3-4) were also allowed.

If, instead of water, hardness water with 2° German hardness was used for the tests, then formulations according to the invention were likewise always superior to the corresponding comparison formulations as far as inhibiting the glass corrosion is concerned.

II.3 Results

The results are summarized in table 2.

TABLE 2
Results of the tests with dishwasher (continuous operation)

| | | | | | Weight loss | Weight loss | Visual | | Visual | |
|---|---|---|---|---|---|---|---|---|---|---|
| | Base | (A.1) | (B) | (C) | champagne | brandy glass | assessment | | assessment | |
| Example No. | mixture: [g] | [g] | [mg] | [g] | glass [mg] | [mg] | champagne glass | | brandy glass | |
| C-1 | Base-1: 13 | 5 | — | — | 54.40 | 32.10 | L1, | T1-2 | L1, | T2 |
| C-2 | Base-2: 10 | 8 | — | — | 62.10 | 34.80 | L1, | T1-2 | L1, | T2 |
| C-3 | Base-1: 13 | 5 | — | 1 (C.1) | 51.30 | 30.20 | L1-2, | T1-2 | L2, | T2 |
| C-4 | Base-2: 10 | 8 | — | 2 (C.1) | 49.40 | 29.40 | L2, | T1-2 | L2, | T2 |
| C-5 | Base-1: 13 | 5 | — | 1.5 (C.2) | 50.00 | 31.10 | L1-2, | T1-2 | L2, | T2 |
| C-6 | Base-2: 10 | 8 | — | 2 (C.2) | 51.20 | 30.60 | L1-2, | T1-2 | L2, | T2 |
| C-7 | Base-2: 10 | 8 | 25 (B.1) | — | 27.2 | 18.7 | L2-3, | T4 | L3, | T4 |
| C-8 | Base-1: 13 | 5 | 30 (B.4) | — | 31.4 | 20.3 | L2-3, | T3-4 | L2-3, | T3-4 |
| 2 | Base-1: 13 | 5 | 20 (B.1) | 1 (C.1) | 17.1 | 11.0 | L4, | T4-5 | L4, | T4-5 |
| 3 | Base-1: 13 | 5 | 30 (B.2) | 2 (C.2) | 11.3 | 8.0 | L4-5, | T4-5 | L4-5, | T4-5 |
| 4 | Base-1: 13 | 5 | 30 (B.3) | 2 (C.1) | 13.8 | 8.6 | L4-5, | T4-5 | L4, | T4-5 |
| 5 | Base-1: 13 | 5 | 15 (B.4) | 1.5 (C.2) | 20.1 | 12.5 | L4, | T4 | L4, | T4 |
| 6 | Base-1: 13 | 5 | 40 (B.5) | 2 (C.2) | 24.9 | 14.8 | L4, | T3-4 | L3-4, | T3-4 |
| 7 | Base-1: 13 | 5 | 40 (B.6) | 2 (C.2) | 28.7 | 16.4 | L3, | T3 | L3-4, | T3-4 |
| 8 | Base-2: 10 | 8 | 40 (B.7) | 2 (C.1) | 21.3 | 12.3 | L4, | T4 | L4, | T3-4 |
| 9 | Base-2: 10 | 8 | 35 (B.8) | 1.5 (C.1) | 19.1 | 13.3 | L4, | T4 | L4, | T3-4 |
| 10 | Base-2: 10 | 8 | 40 (B.2) | 1.5 (C.1) | 10.6 | 6.6 | L4-5, | T4-5 | L4-5, | T5 |
| 11 | Base-2: 10 | 8 | 40 (B.1) | 2 (C.2) | 11.6 | 6.9 | L5, | T4-5 | L4-5, | T4-5 |
| 12 | Base-2: 10 | 8 | 40 (B.3) | 2 (C.2) | 13.8 | 8.4 | L4-5, | T4-5 | L4, | T4-5 |
| 13 | Base-2: 10 | 8 | 40 (B.9) | 2 (C.2) | 30.1 | 15.8 | L3, | T3 | L2-3, | T3 |
| 14 | Base-1: 13 | 5 | 20 (B.1) | 1 (C.1) | 16.4 | 10.3 | L4-5, | T4-5 | L4-5, | T4-5 |
| 15 | Base-1: 13 | 5 | 30 (B.2) | 1 (C.2) | 12.9 | 9.8 | L4-5, | T4-5 | L4-5, | T4-5 |
| 16 | Base-1: 13 | 5 | 30 (B.3) | 1.5 (C.1) | 14.1 | 9.2 | L4-5, | T4-5 | L4, | T4-5 |
| 17 | Base-1: 13 | 5 | 15 (B.4) | 1.5 (C.2) | 19.6 | 12.0 | L4, | T4 | L4, | T4 |
| 18 | Base-1: 13 | 5 | 40 (B.5) | 2 (C.2) | 26.9 | 16.0 | L4, | T3-4 | L3-4, | T3-4 |

1. A method for washing a dish or a kitchen utensil, the method comprising: washing the dish or the kitchen utensil with a solid formulation having a residual moisture content of from 0.1 to 15% by weight to the dish or kitchen utensil,
wherein the solid formulation comprises:
a first at least one compound selected from the group consisting of an aminocarboxylate and a polyaminocarboxylate;
a cationic (co)polymer having a cationic charge density of at least 5 milliequivalents/g;
at least one silicate selected from the group consisting of an sodium silicate, a potassium silicate, and an alumosilicate;
optionally, a second at least one compound selected from the group consisting of an alkali metal percarbonate, an alkali metal perborate, and an alkali metal persulfate; and
optionally, polyvinyl alcohol.

2. The method according to claim 1, wherein the solid formulation is free from a phosphate and a polyphosphate.

3. The method according to claim 1, wherein the cationic (co)polymer is polyvinylamine or a linear or branched homopolymer of alkyleneimine.

4. The method according to claim 1, wherein the solid formulation has a heavy metal content below 0.05 ppm, based on a solid content of the solid formulation.

5. The method according to claim 1, wherein the aminocarboxylate or the polyaminocarboxylates of the first at least one compound is selected from the group consisting of methylglycine diacetate (MGDA), iminodisuccinic acid (IDS), glutamic acid diacetate, and a salt thereof.

6. The method according to claim 1, wherein the at least one silicate has an average primary particle diameter of at most 1 μm.

7. The method according to claim 1, wherein the solid formulation comprises:
from 1 to 50% by weight of the first at least one compound;
from 0.001 to 2% by weight of the cationic (co)polymer;
from 1 to 30% by weight of the at least one silicate;
from zero to 15% by weight of bleach as the second at least one compound; and
from zero to 5% by weight of the polyvinyl alcohol,
independently based on the solid content of the solid formulation.

8. The method according to claim 1, wherein at least one surface of the dish and or the kitchen utensil is made of glass or ceramic, which is optionally decorated.

9. The method according to claim 1, wherein the washing is washing with a dishwasher.

10. A solid formulation having a residual moisture of from 0.1 to 15% by weight, the solid formulation comprising:
a first at least one compound selected from the group consisting of an aminocarboxylate and a polyaminocarboxylate;
a cationic (co)polymer having a cationic charge density of at least 5 milliequivalents/g;
at least one silicate selected from the group consisting of an sodium silicate, a potassium silicate, and an alumosilicate;
optionally, a second at least one compound selected from the group consisting of an alkali metal percarbonate, an alkali metal perborate, and an alkali metal persulfate; and
optionally, polyvinyl alcohol.

11. The solid formulation according to claim 10, which is free from a phosphate and a polyphosphate.

12. The solid formulation according to claim 10, wherein the cationic (co)polymer is polyvinylamine or a linear or branched homopolymer of alkyleneimine.

13. The solid formulation according to claim 10, wherein the solid formulation has a heavy metal content below 0.05 ppm, based on a solid content of the solid formulation.

14. The solid formulation according to claim 10, wherein the aminocarboxylate or the polyaminocarboxylates of the first at least one compound is selected from the group consisting of methylglycine diacetate (MGDA), iminodisuccinic acid (IDS), glutamic acid diacetate, and a salt thereof.

15. The solid formulation according to claim 10, comprising:
from 1 to 50% by weight of the first at least one compound;
from 0.001 to 2% by weight of the cationic (co)polymer;
from 1 to 30% by weight of the at least one silicate;
from zero to 15% by weight of bleach as the second at least one compound; and
from zero to 5% by weight of the polyvinyl alcohol,
independently based on the solid content of the solid formulation.

16. The solid formulation according to claim 10, wherein the at least one silicate has an average primary particle diameter of from 10 to 1000 nm.

17. A method for producing the solid formulation according to claim 10, the process comprising:
mixing, in the presence of water,
a first at least one compound selected from the group consisting of an aminocarboxylate and a polyaminocarboxylate,
a cationic (co)polymer having a cationic charge density of at least 5 milliequivalents/g,
a silicate or waterglass,
optionally, a second at least one compound selected from the group consisting of an alkali metal percarbonate, an alkali metal perborate, and an alkali metal persulfate, and
optionally, polyvinyl alcohol; and
partially removing the water.

18. The method according to claim 17, wherein the partially removing comprises partially removing the water completely or partially by compaction, spray-drying, or spray-granulation.
